(19) United States
(12) Patent Application Publication
(10) Pub. No.: US 2014/0379691 A1
(43) Pub. Date: Dec. 25, 2014

(54) DATABASE QUERY PROCESSING WITH REDUCE FUNCTION CONFIGURATION

(71) Applicant: Microsoft Corporation, Redmond, WA (US)

(72) Inventors: Nikhil Teletia, Madison, WI (US); Alan Dale Halverson, Verona, WI (US); Jignesh M. Patel, Madison, WI (US)

(21) Appl. No.: 13/923,772

(22) Filed: Jun. 21, 2013

(51) Int. Cl. G06F 17/30

(52) U.S. Cl. CPC G06F 17/30395; G06F 17/30442
USPC 707/713

(57) ABSTRACT

A distributed system that includes multiple database compute nodes, each operating a database. A control node provides a database interface that offers a view on a single database using parallel interaction with the multiple compute nodes. The control node helps perform a map reduce operation using some or all of the compute nodes in response to receiving a database query having an associated function that is identified as a reduce function. The control node evaluates the target data of the database query to identify one or more properties of the content of the target data. The reduce function is then configured based on these identified properties.

### BACKGROUND

A Parallel Data Warehouse (PDW) architecture includes a number of distributed compute nodes, each operating a database. One of the compute nodes is a control node that presents an interface that appears as a view of a single database, even though the data that supports this illusion is distributed across multiple databases on corresponding compute nodes.

The control node receives a database query, and optimizes and segments the database query so as to be processed in parallel at the various compute nodes. The results of the computations at the compute nodes are passed back to the control node. The control node aggregates those results into a database response. That database response is then provided to the entity that made the database query, thus facilitating the illusion that the entity dealt with only a single database.

### SUMMARY

In accordance with at least one embodiment described herein, a distributed system includes multiple compute nodes, each operating a database. A control node provides a database interface that offers a view on a single database using parallel interaction with the multiple compute nodes. The control node helps perform a map reduce operation using some or all of the compute nodes in response to receiving a database query having an associated function that is identified as a reduce function. The control node evaluates the target data of the database query to identify one or more properties of the content of the target data. It is based on these identified one or more properties that the reduce function is configured.

In some embodiments, the database query may also have an associated map function. Execution of such a map function may be distributed across the multiple compute nodes. The control node operates to optionally optimize, and also segment the database query into sub-queries. The control node dispatches those sub-queries to each of the one or more compute nodes that are to perform the map function on a portion of the target data that is located on that compute node. The results from the map function may then be partitioned by key, and dispatched to the appropriate reduce component. The control node aggregates the results, and responds to the database query. From the perspective of the issuer of the query, the issuer submits a database query and receives a response just as if the issuer would do if interacting with a single database, even though responding to the database query involves multiple compute nodes performing operations on their respective local databases. Nevertheless, through the control node performing parallel communication with the compute nodes, the database query was efficiently processed even if the target data is large and distributed.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a system that includes multiple compute nodes configured to function as a parallel data warehouse;

FIG. 3 illustrates a flowchart of a method for processing a database query in a manner that presents a view of a single database to external entities;

FIG. 4 illustrates an example flow associated with a map-reduce paradigm;

FIG. 5 illustrates an example structure of a database query that is received, and which assists in performing a map reduce paradigm (such as that of FIG. 4) over a parallel data warehouse system (such as that of FIG. 2); and

FIG. 6 illustrates a flowchart of a method for processing a database query to thereby perform a map reduce operation.

### DETAILED DESCRIPTION

In accordance with embodiments described herein, a distributed system that includes multiple database compute nodes is described. Each compute node operates a database. A control node provides a database interface that offers a view on a single database using parallel interaction with the multiple compute nodes. The control node helps perform a map reduce operation using some or all of the compute nodes in response to receiving a database query having an associated function that is identified as a reduce function. The control node evaluates the target data of the database query to identify one or more properties of the content of the target data. The reduce function is then configured based on these identified properties.

In some embodiments, the database query may also have an associated map function. Execution of such a map function may be distributed across the multiple compute nodes. The control node operates to optionally optimize, and also segment the database query into sub-queries. The control node dispatches those sub-queries to each of the one or more compute nodes that are each to perform the map function on a portion of the target data that is located on that compute node. The results from the map function may then be partitioned by key, and dispatched to the appropriate reduce component. The control node aggregates the results, and responds to the database query. From the perspective of the issuer of the query, the issuer submits a database query and receives a response just as if the querier would do if interacting with a single database, even though responding to the database query involves multiple compute nodes performing operations on their respective local databases. Nevertheless, through the control node performing parallel communication with the compute nodes, the database query was efficiently processed even if the target data is large and distributed.

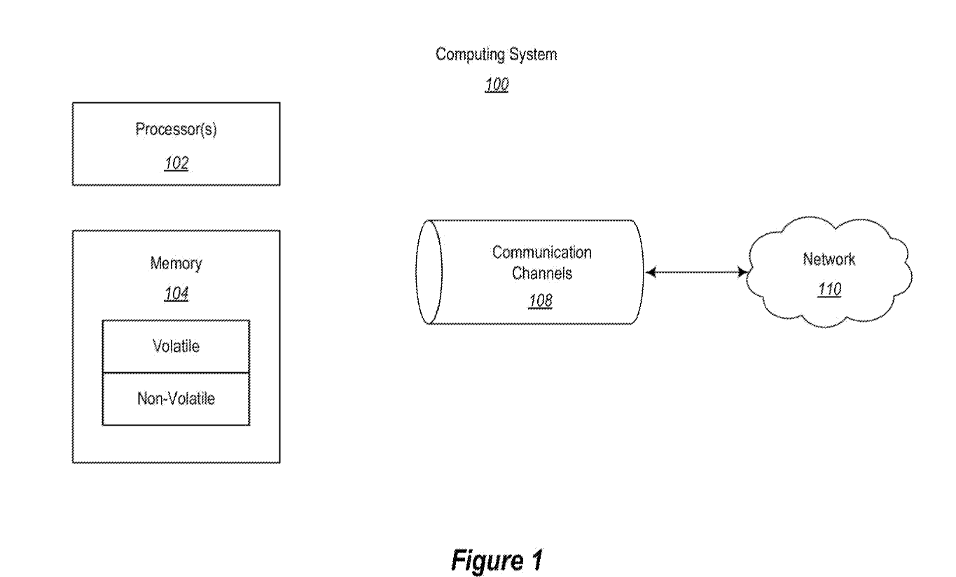

Some introductory discussion of a computing system will be described with respect to FIG. 1. Then, the principles of the performing map reduce operations in a parallel in a database management system will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 includes at least one processing unit 102 and computer-readable media 104. The computer-readable media 104 may conceptually be thought of as including physical system memory, which may be volatile, non-volatile, or some combination of the two. The computer-readable media 104 also conceptually includes non-volatile mass storage. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads). Such executable modules may be managed code in the case of being executed in a managed environment in which type safety is enforced, and in which processes are allocated their own distinct memory objects. Such executable modules may also be unmanaged code in the case of executable modules being authored in native code such as C or C++.

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface controller (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

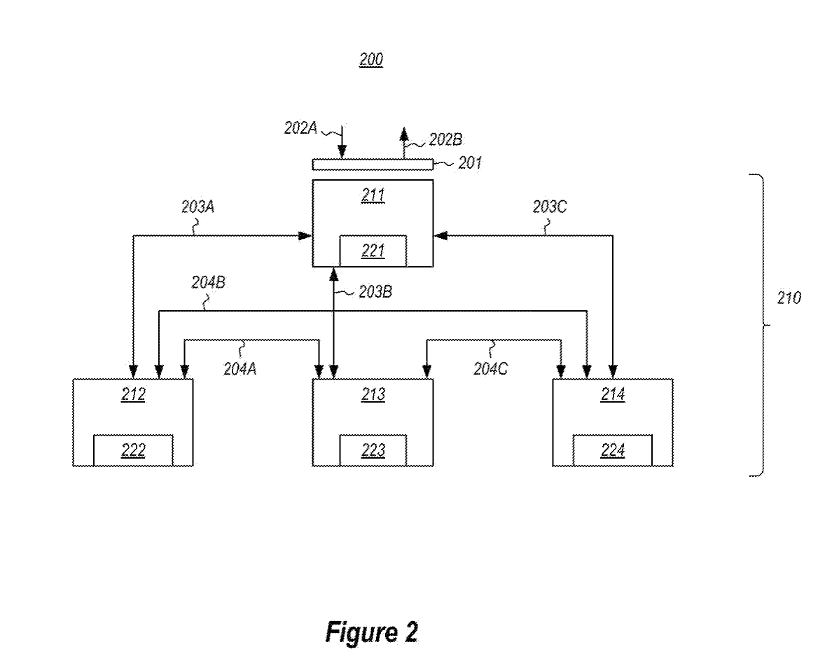

FIG. 2 illustrates a system 200 that includes multiple compute nodes 210. For instance, the compute nodes 210 are illustrated as including four compute nodes 211 through 214. Each of the compute nodes 211 through 214 includes a corresponding database 221 through 224, respectively. The compute nodes are hierarchically structured. In particular, one of the compute nodes 211 is a control node. The control node 211 provides an interface 201 that receives database queries 202A from various external entities, and provides corresponding database responses 202B.

The database managed by the system 200 is distributed. Thus, the data of the database is distributed across some or all of the databases 221 through 224. Entities that use the system 200 interface using the interface 201. The communication paths between the control node 211 and the compute nodes 212 through 214 are represented using arrows 203A through 203C, respectively. Likewise, the compute nodes 212 through 214 may communicate with each other using communication paths represented by arrows 204A through 204C. Ideally, however, the sub-queries are carefully formulated so little, if any, data needs to be transmitted over communication paths 204A through 204C between the compute nodes 212 through 214.

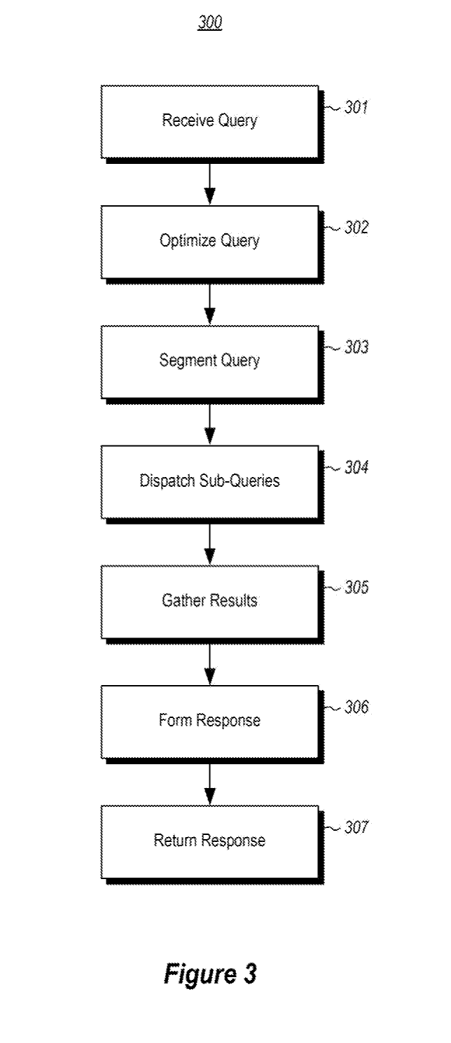

The interface 201 might not be an actual component, but simply might be a contract (such as an Application Program Interface) that the external entities use to communicate with the control node 211. That interface 201 may be the same as is used for non-distributed databases. Accordingly, from the viewpoint of the external entities that use the system 200, the system 200 is but a single database. The flow elements of FIG. 2 will be described with respect to the operation of FIG. 3.

FIG. 3 illustrates a flowchart of a method 300 for processing a database query in a manner that presents a view of a single database to external entities. The control node 211 receives a database query 202A in a manner that is compatible with the interface 201 (act 301). Optionally, the control node 211 then optimizes the query (act 302). The control node 211 then segments the query into sub-queries (act 303).

Each sub-query might be, for example, compatible with a database interface that is implemented at the corresponding compute node that is to handle processing of the corresponding sub-query. The sub-queries may express a subset of the original target data specified in the database request 202A. The control node 211 may use the distribution of the data within the system 300 in order to determine how to properly divide up the original database query. Thus, the work of satisfying the database query is handled by apportioning the work closest to where the data actually resides.

The control node 211 then dispatches the sub-queries (act 304), each towards the corresponding compute nodes 211 through 214. Note that the control node 211 may also serve to satisfy one of the sub-queries, and thus this would involve the control node 211 dispatching the sub-query to itself in that case. The control node 211 then monitors completion of the sub-queries and gathers the results (act 305), formulates a database response using the gathered results (act 306), and sends the database response (act 307) back to the entity that submitted the database query.

In this manner, the control node 211 provides a view that the system 200 is but a single database since entities can submit database queries to the system 200 (to the control node 211) using a database interface 201, and receive a response to that query via the database interface 201. In accordance with the principles described herein, a map reduce paradigm may be further incorporated into the system 200.

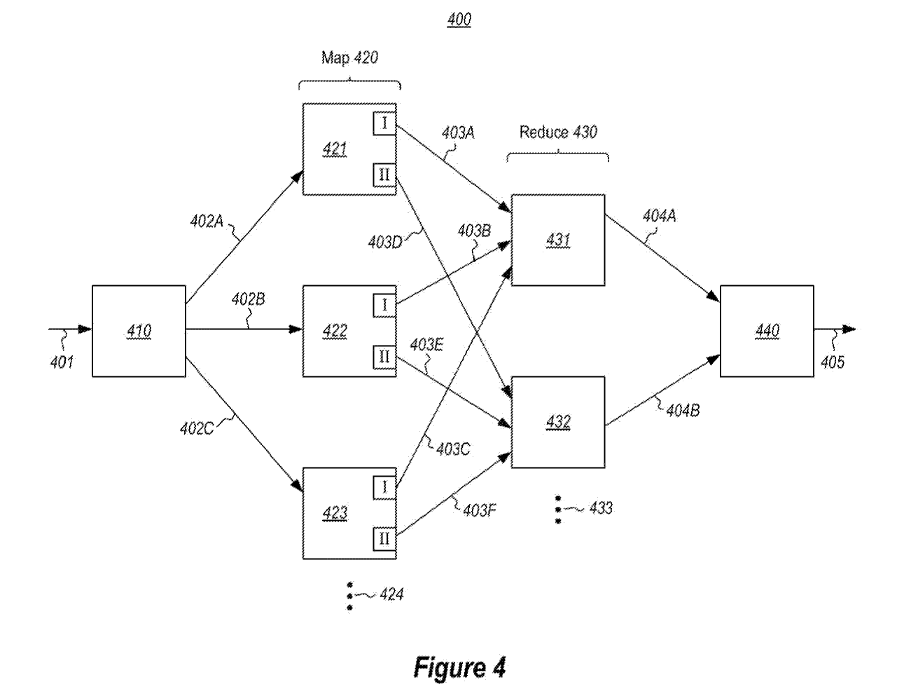

FIG. 4 illustrates an example flow 400 associated with a map-reduce paradigm. The initial work assignment 401 is received into a work divider 410. The work divider 410 divides the work assignment 401 into sub-assignment 402A, 402B and 402C, and forward those sub-assignments to the map stage 420 of the map reduce paradigm.

The map stage 420 performs the map function on the target data of the original work assignment 401. This is accomplished using one or more components that are each capable of performing the map function. For instance, in FIG. 4, the map stage 420 includes three map components 421 through 423, although the ellipses 424 represents that there may be any number of map components in the map stage 420 that perform the map function. As an example, each of the map components in the map stage 420 might be an instance of a single class of map function. The map function comprises sorting, filtering, and/or annotating the input data to produce intermediate data (also called herein “map results”).

The map components 421 through 423 perform mapping on different portions of the original target data identified in the original work request 401. The mapped results include a multitude of key-value pairs. Those results are partitioned by key. For instance, in FIG. 4, each of the map components 421 through 423 partitions the map results into two partitions I or II. That said, the map components might partition the map results into any number of partitions.

A reduce stage 430 includes one or more reduce components that each perform a reduce function for all map results from the map stage that fall into a particular partition. For instance, in FIG. 4, the reduce stage 430 is illustrated as including two reduce components 431 and 432, although the ellipses 433 represents that the principles described herein apply just as well regardless of the number of reduce components in the reduce stage 430. Each reduce component 431 through 433 performs the reduce function. As an example, each of the reduce components 431 through 433 might be an instance of the same reduce function.

As previously mentioned, in the case of FIG. 4, there are two partitions I and II for the output of each map function component, and each reduce component handles map results from a particular partition. For instance, map components 421 through 423 may each generate intermediate output in partition I, and forward such output to the reduce component (reduce component 431) responsible for the partition I as represented by arrows 403A, 403B and 403C. Map components 421 through 423 may also each generate intermediate output in partition II, and forward such output to the reduce component (reduce component 432) responsible for the partition II as represented by arrows 403D, 403E and 403F.

The results from the reduce stage 430 are then forwarded to an aggregator 440 (as represented by arrows 404A and 404B) which aggregates the reduce results to generate work assignment output 405.

In accordance with the principles described herein, a map reduce paradigm (such as that of FIG. 4) is superimposed upon the parallel data warehouse paradigm (such as that of FIG. 2). For instance, the work divider 410 and the aggregator 440 may be implemented by the control node 211 of FIG. 2. The map components 421 through 423 may each be implemented by one of the compute nodes 211 through 214 of FIG. 2. For instance, the map component 421 may be the compute node 211, as there is no requirement that the control node 211 may not also act to process one of the sub-queries. Furthering the example, the map component 422 might be the compute node 212, and the map component 423 might be the compute node 213. The map components rely more on potentially voluminous input data, and thus the map components 421 through 423 are preferably local to the portion of the target data that they process. On the other hand, there is less restriction on placement of the reduce components 421 and 422, which may operate on any of the compute nodes 211 through 214.

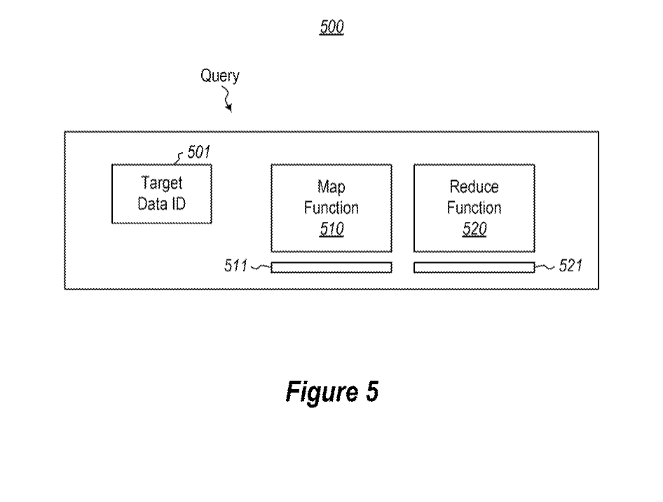

FIG. 5 illustrates an example structure of a database query 500 that is received, and which assists in performing a map reduce paradigm (such as that of FIG. 4) over a parallel data warehouse system (such as that of FIG. 2). The database query 500 includes target data identification 501 that identifies target data that is distributed across the compute nodes 210 and that is to be the subject of the database query 400. The database query 500 has a corresponding map function 510 and/or a corresponding reduce function 520.

Such functions might be, for example, identified within the database query 500 or perhaps the correspondence might be found based on the context of the database query 500. For instance, perhaps there is a default map function and/or a default reduce function when the database query 500 indicates that the map-reduce paradigm is to be applied to the database query 500, but the database query does not otherwise identify a specific map function and/or a specific reduce function. Alternatively, the map function and/or the reduce function might be expressly identified in the database query 500. Even further, the database query might even include some or all of the code associated with the map function and/or the reduce function.

The database query 500 further includes an instruction 511 to feed data from the local database one row at a time into the map function. Accordingly, the map component (e.g., components 421, 422 or 423) operates upon the sub-query (402A, 402B or 402C, respectively) such that one row at a time is fed to the map component from the database that is local to whichever compute node is executing the map component.

The results of the map function may be structured in accordance with a database schema. The database query may further include an instruction 521 to feed data from the local database one row at a time into the reduce function. Accordingly, the reduce component (e.g., components 431 or 432) operates upon the partitioned results from the map function such that one row at a time is fed to the reduce component from the partitioned results.

Referring back to FIG. 2, the control node 211 performs a method 600 for processing a database query to thereby perform a map reduce operation. Although not required, the control node 211 may access a computer program product comprising one or more computer-readable storage media having thereon computer-executable instructions that are structured such that, when executed by one or more processors of the control node 211, the control node 211 performs the method 600.

The method 600 is initiated upon receiving a database query (act 601). For instance, the control node might receive the database query 500 of FIG. 5. The method 600 then determines target data that is to be operated upon in processing the database query (act 602). For instance, the target data identification 501 of the database query 500 may be used to identify the target data.

The control node then determines whether a map function is associated with the database query (decision block 603). This might be accomplished by first determining that a function is associated with the database query, and then determining that the function is a map function. If there is no map function associated with the database query (“No” in decision block 603), processing proceeds to an evaluation of whether or not there is a reduce function associated with the database query (decision block 606). This might be accomplished by first determining that a function is associated with the database query, and then determining that the function is a reduce function.

If there is a map function associated with the database query (“Yes” in decision block 603), the control node identifies the map function (act 604), and determines how to segment the database query amongst multiple compute nodes (act 605). This determination will be based on information regarding which data of the target data is present in each compute node.

The control node then determines whether or not there is any reduce function associated with the query (decision block 606). If not (“No” in decision block 606), then the control node simply formulates the one or more queries (act 607). In the case of there being a map function and multiple sub-queries segmented from the original database query, then this act will involve formulating all of the sub-queries. If the database request includes an instruction 511 to feed the input data one row at a time to the map function, then the sub-queries are each structured such that the corresponding control node performs the map function row by row, one at a time.

If there is a reduce function associated with the query (“Yes” in decision block 606), then the control node evaluates the target data (act 608) to identify one or more properties of the content of the target data. The control node then configures one or more reduce components (act 609) to run in response to the identified properties. This might be accomplished by including configuration instructions in the queries, such that each map component knows which reduce component to send results to based on partitioning. The queries are then constructed (act 607), and dispatched (act 610). Such dispatch occurs to the map stage if a map function is to be performed, or directly to the reduce stage if no map function is to be performed. In some case, this might actually involve allowing the map function to first be performed on the target data, such that the one or more properties are identified based on results of the map function. Thus, acts 607 and 608 would await results from the map function first. Later dispatch of the results would be made to the reduce function.

The control node then formulates a database response (act 611) to the database query using results from the reduce function if there is a reduce function, or from the map function if there is no reduce function. The control node then dispatches the database response (act 612) to the entity that provided the database query

An example of the utility of the use of the map reduce paradigm in the contact of the environment 200 will be described with respect to a sessionization example. In sessionization, the task is to divide a set of user interaction events (such as clicks) into sessions. A session is defined to include all the clicks by a user that occurs within a specified range of time to each another. The following Table 1 illustrate an example of raw data that may be subject to sessionization:

TABLE 1

| User ID | Timestamp |
|---|---|
| 1 | 12:00:00 |
| 2 | 00:10:10 |
| 1 | 12:01:34 |
| 2 | 02:20:21 |
| 1 | 12:01:10 |
| 1 | 12:03:00 |

The following query may perform sessionization in this raw data.

SELECT userid, timestamp, session.t_count
FROM session_data
CROSS APPLY
sessionization(userid, timestamp, 60) session

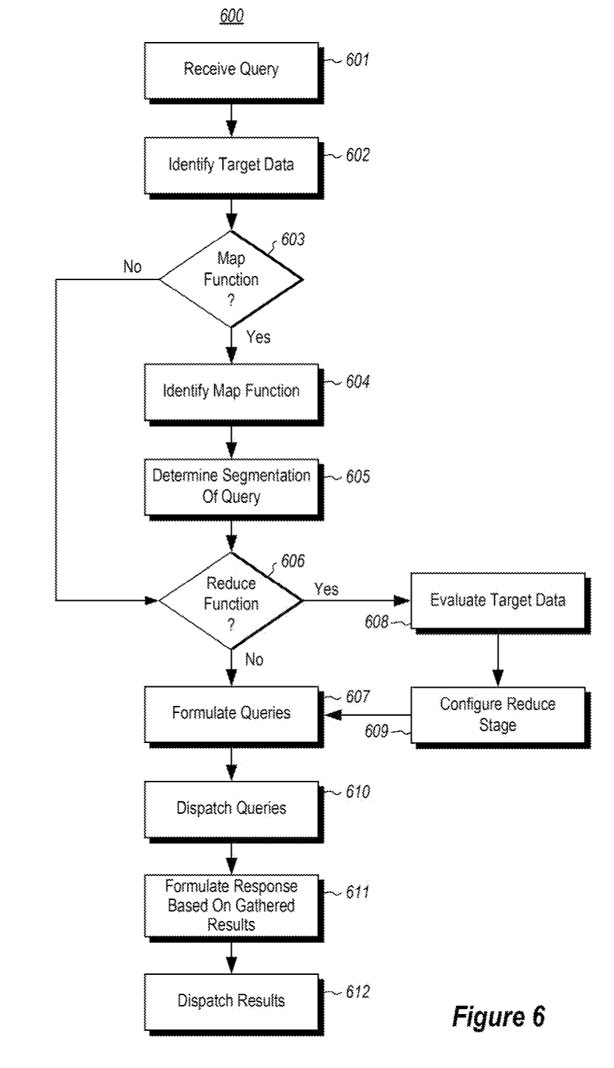

The query above represents an example of the database query 500 of FIG. 5, and which could be processed using the method 600 of FIG. 6. The 60 parameter indicates that all events that occurred within 60 seconds of each other for a given user, are to be considered part of the same session. Sessionization according to the query is to be accomplished on Table 1. This simple event table contains only the timestamp and the userid associated with the user interaction event. The resulting table in which each event is assigned to a session is illustrated in the following Table 2:

TABLE 2

| User ID | Timestamp | Session |
|---|---|---|
| 1 | 12:00:00 | 0 |
| 1 | 12:01:10 | 1 |
| 1 | 12:01:34 | 1 |
| 1 | 12:03:00 | 2 |
| 2 | 00:10:10 | 0 |
| 2 | 02:20:21 | 1 |

Sessionization can be accomplished using the SQL database query language, but the principles described herein make it easier to express and improve the performance of the sessionization task. The principles described herein may be accomplished using only one pass over Table 1 once the table is partitioned on userid.

Execution plan for the above depends upon the distribution of Table 1. There are two cases to consider. The first case is that the table is already partitioned according to the User ID column.

SELECT userid, timestamp, t_count
FROM (SELECT TOP N * FROM h_session_data_[PARTITION_ID]
ORDER BY userid, timestamp)
CROSS APPLY
sessionization(userid, timestamp, 60) session

In this case, the FROM statement represents the map function. The h_session_data_[PARTITION_ID] structure represents horizontal partition data. The sessionization function represents the reduce function. The CROSS APPLY instruction is the instruction to apply one row at a time from the results of the map function to the reduce function called “sessionization”.

The second case would be that the table is partitioned according to the timestamp. A temporary distributed table temp1 is created by redistributing Table 1 on the column userid. After redistribution the following query may be executed on the individual nodes:

SELECT userid, timestamp, t_count
FROM (SELECT TOP N * FROM h_temp1_[PARTITION_ID] ORDER
BY userid, timestamp)
CROSS APPLY
Sessionization (userid, timestamp, 60) session

In this case, the FROM statement represents the map function. The h_temp1_[PARTITION_ID] structure represents horizontal partition data. The sessionization function represents the reduce function. The CROSS APPLY instruction is the instruction to apply one row at a time from the results of the map function to the reduce function called “sessionization”.

Thus, in this example, and in the broader principles described herein, the control node was able to use one or more properties of the target data in order to configure the reduce stage.

A second example will now be provided in which a count of different words in a document is performed using map-reduce functionality in a database. Databases are generally ill-suited for analyzing unstructured data. However, the principles provided herein allow a user to push procedural code into the database management system for transforming unstructured data into a structured relation. The following query is provided for purposes of example:

SELECT token, count(*)
FROM document
CROSS APPLY
tokenizer(textData, |)
GROUP BY token

The function “tokenizer” in this query creates tokens from the textData column based on the specified delimiter. The textData column includes unstructured text on which tokenization will be done. The “|” represents a word tokenizer that represents how to split the text into words. “|” might be a space or a user-defined value. Map-reduce in a parallel database management system allows users to focus on the computationally interesting aspect of the problem—tokenizing the input—while leveraging the available database query infrastructure to perform the grouping and the counting of unique words. In the work count task, the function “tokenizer” can have additional complex logic such as text parsing and stemming.

The map function “tokenizer” works on an individual row so the distribution of the table document is not a concern. In this case, the execution plan is that each node will execute the tokenizer function on the local horizontal partitions of the table document. This approach allows the query optimizer to leverage the existing parallel query optimizer for computing the aggregate count in parallel.

Thus, an effective mechanism for perform map-reduce functionality in a parallel database management system has been disclosed herein. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a plurality of compute nodes, each operating a database;
a control node configured to provide a database interface that provides a view of a single database using parallel interaction with the plurality of compute nodes,
wherein the control node is configured to perform a method for performing a map reduce operation using at least some of the plurality of compute nodes in response to receiving a database query having an associated function that is identified as a reduce function and identifying target data upon which the database query is to operate, the target data being distributed across the at least some of the plurality of compute nodes, the method comprising:
an act of evaluating the target data to identify one or more properties of the content of the target data; and
an act of configuring one or more reduce components capable of performing a reduce function to be run in response to the identified one or more properties.

2. The system in accordance with claim 1, wherein the one or more reduce components comprise a single reduce function.

3. The system in accordance with claim 1, wherein the one or more reduce components comprises a plurality of reduce components, each comprises an instance of a same reduce function class.

4. The system in accordance with claim 1, wherein the database query also has a corresponding map function, the method further comprising:
an act of segmenting the database query into a plurality of sub-queries that are structured to be interpretable by a compute node as an instruction for the compute node to perform a map function on a portion of the target data that is present at the compute node; and
an act of dispatching each of the plurality of sub-queries to a corresponding compute node of the plurality of compute nodes.

5. The system in accordance with claim 4, wherein the map function is identified in the database query.

6. The system in accordance with claim 4, wherein the map function is coded in the database query.

7. The system in accordance with claim 4, wherein the database query includes an instruction to feed data one row at a time into a map component that performs the map function.

8. The system in accordance with claim 4, wherein results of the map function are structured in a database schema.

9. The system in accordance with claim 4, wherein the act of evaluating the target data to identify one or more properties of the content of the target data, comprises:
an act of evaluating output of the operation of the map function.

10. The system in accordance with claim 1, wherein the act of evaluating the target data to identify one or more properties of the content of the target data, comprises:
an act of evaluating the target data without using a map function.

11. The system in accordance with claim 1, the method further comprising:
an act of formulating a response to the database query using results from the reduce function.

12. The system in accordance with claim 1, wherein the reduce function is identified in the database query.

13. The system in accordance with claim 1, wherein the reduce function is coded in the database query.

14. The system in accordance with claim 1, wherein the database query includes an instruction to feed data into the reduce function one row at a time.

15. A computer program product comprising one or more computer-readable storage media having thereon computer-executable instructions that are structured such that, when executed by one or more processors of a control node communicatively coupled to a plurality of compute nodes, each operating a database, cause the computing system to perform a method for processing a database query that is to operate on target data in response to receiving the database query, the method comprising:
an act of identifying that a function is associated with the database query that is to operate upon target data that is distributed across the plurality of control nodes;
an act of identify that the function is a reduce function;
an act of evaluating the target data to identify one or more properties of the content of the target data; and
an act of configuring one or more reduce functions capable of performing the reduce function to be run in response to the identified one or more properties.

16. The computer program product in accordance with claim 15, the method further comprising:
an act of segmenting the database query into a plurality of sub-queries that are structured to be interpretable by a compute node as an instruction for the compute node to perform a map function on a portion of the target data that is present at the compute node; and
an act of dispatching each of the plurality of sub-queries to a corresponding compute node of the plurality of compute nodes.

17. The computer program product in accordance with claim 15, wherein the act of evaluating the target data to identify one or more properties of the content of the target data, comprises:
an act of evaluating output of the operation of the map function.

18. The computer program product in accordance with claim 15, further comprising:
an act of formulating a response to the database query using results from the reduce function.

19. A method for processing a database query, the method comprising:
an act of receiving a database query that identifies target data that is distributed across the plurality of control nodes;
an act of identifying that a function is associated with the database query;
an act of identify that the function is a reduce function;
an act of evaluating the target data to identify one or more properties of the content of the target data; and
an act of configuring one or more reduce components capable of performing a reduce function to be run in response to the identified one or more properties.

20. The method in accordance with claim 19, further comprising:
an act of formulating a response to the database query using results from the reduce function.
